(19) United States
(12) Patent Application Publication
(10) Pub. No.: US 2011/0236615 A1
(43) Pub. Date: Sep. 29, 2011

(54) MOLDED PART

(76) Inventors: Roland Hendel, Aurachtal (DE); Guido Kania, Marloffstein (DE)

(21) Appl. No.: 12/671,701

(22) PCT Filed: Aug. 1, 2008
(86) PCT No.: PCT/EP2008/006334

§ 371 Date: May 19, 2010

(30) Foreign Application Priority Data
Aug. 3, 2007 (DE) 20 2007 010 891.5

(51) Int. Cl. B32B 1/08; B82Y 30/00

(52) U.S. Cl. 428/36.91; 428/36.9; 977/773

(57) ABSTRACT

The invention relates to a molded plastic part, preferably a plastic tube, especially for conveying or storing fluids, comprising at least one layer that contains zeolite particles in which at least some ion-exchangeable ions are replaced by biofilm-inhibiting ions. Said plastic tube is characterized in that the layer and/or other layers additionally contain/s nanometer-sized biofilm-inhibiting particles.

The present invention relates to a plastic molded part, preferably a plastic pipe, in particular for conveying or storing fluids, having at least one layer that contains zeolite particles in which at least some ion-exchangeable ions have been replaced by biofilm-inhibiting ions.

The prior art according to the publication EP A 116865 discloses providing plastics with zeolite particles, with the zeolite particles containing ions having a biofilm-inhibiting and/or antimicrobial effect. In this context, “biofilm” should be understood to refer generally to the surface accumulation of organisms and, in particular, microorganisms such as bacteria or fungi on the surfaces of corresponding molded parts.

One special use of said plastics is pipes for conveying or storing fluids and/or gaseous media. Such plastic pipes are used, for example, to convey drinking water from drinking water reservoirs to consumers and for returning waste water from the consumer to waste water treatment facilities.

In the case of the plastic pipes mentioned above in the area of drinking water conveyance, it is usual for a colonization of the inner wall of the pipe to occur with organisms and/or microorganisms. In this case, organisms may be plants such as algae, while microorganisms may include, for example, bacteria and fungi. The corresponding accumulations lead on the one hand to a reduced flow cross section and, on the other hand, to a negative influence on the quality of the drinking water conveyed by the pipes. It is even possible for an epidemiological risk to occur if the biofilms formed inside the pipes contain pathogenic organisms. In addition to the problems mentioned above, the microorganisms in the biofilm cause biologically induced damage to the pipe material in cases of prolonged exposure. In this context, degradation of the plastic by fungus should be mentioned.

The incorporation of zeolite particles with biofilm-inhibiting ions into such plastic pipes can inhibit or eliminate the formation of a biofilm. However, a disadvantage of this method for preventing the formation of a biofilm is the fact that the biofilm-inhibiting ions present in the zeolite particles dissolve relatively quickly out of the zeolite and wander to the corresponding surface of the molded part, such that the biofilm-inhibiting ions are quickly exhausted and the biofilm-inhibiting effect is lost after a short time.

The object of the invention is therefore to provide a molded plastic part, preferably a plastic pipe, that effectively prevents deposits of microorganisms or contaminants, as well as the formation of a biofilm in general, for a long period of time and, at the same time, may be produced in a cost-effective manner.

This object is attained in a molded plastic part having the features of the pre-characterizing portion of claim 1 by the features of the characterizing portion of Claim 1. Other advantageous development describing the invention in detail are listed in the subordinate claims.

The molded plastic part according to the invention is characterized in that the layer additionally contains biofilm-inhibiting particles in the nanometer range in addition to the zeolite particles. It has been shown that, by combining zeolite particles having biofilm-inhibiting ions and biofilm-inhibiting particles in the nanometer range, a very sustained biofilm-inhibiting effect may be achieved. When the plastic pipe is used, first a predominant migration occurs of biofilm-inhibiting ions that are released from the zeolite particles. Thus, virtually from the very beginning, a highly effective protection against a deposit of organisms and/or microorganisms is achieved by the rapid release of the ions and their correspondingly rapid migration to the surface of the plastic pipe.

Over time, a release of ions from the corresponding biofilm-inhibiting particles in the nanometer range occurs as well, and these ions also migrate in the direction of the surface of the plastic pipe and, once there, ensure that no biofilm is deposited. Because the release of ions from the biofilm-inhibiting particles lasts significantly longer than is the case for the zeolite particles, a delayed effect results that is effective somewhat later and that requires somewhat more time for the establishment of an effective protection against the deposit of a biofilm. In any event, significantly more time is required in this instance until the ions of the biofilm-inhibiting particles have been completely exhausted. This results in an optimally effective combination in which the ions of the zeolite particles act very quickly and build up a very early protection against biofilms (while virtually no ions from the biofilm-inhibiting particles are present at this early stage). However, the protection against biofilms that results from the migration of ions from the zeolite particles is consumed relatively quickly, with the corresponding drop in efficacy being bolstered by the migration of ions from the biofilm-inhibiting particles, which begins later. Thus, the ions of the zeolite particles and the biofilm-inhibiting particles in the nanometer range complement each other in an ideal fashion because, as soon as one, i.e., the ions of the zeolite particles, has been consumed, the ions of the biofilm-inhibiting particles come into effect, with a very sustained effect.

In addition to the mechanism of the release of ions from the biofilm-inhibiting particles embedded in the layer, which then as a result migrate to the surface of the plastic pipe to have an effect there, a direct contact also occurs between the biofilm-inhibiting particles located on the surface of the plastic pipe and partially peeking out of said surface. This contact between the biofilm-inhibiting particles and the fluid also causes a release of ions. Over time, the direct contact between the biofilm-inhibiting particles and the fluid plays an increasing role because material of the plastic pipe is worn away by the fluid such that, over time, more and more biofilm-inhibiting particles are exposed.

Here, it may be advantageous for the biofilm-inhibiting ions to include copper ions and/or zinc ions and/or silver ions and for the biofilm-inhibiting particles to comprise copper and/or zinc and/or silver. The materials copper, zinc, and silver as well as their ions have particularly favorable (antimicrobial) properties with regard to preventing the buildup of a biofilm, so they are preferably selected.

In addition, it may be advantageous for the biofilm-inhibiting particles to have a maximum diameter between 1 and 100 nm, preferably 10 and 50 nm. It has been shown that particles in this size range have a particularly advantageous effect.

Moreover, it may be advantageous for the total concentration of zeolite particles and biofilm-inhibiting particles to be 0.01 to 15 percent by weight, preferably 0.1 to 5 percent by weight, relative to the layer of the plastic tube containing said particles. To this end, the amount of zeolite particles and biofilm-inhibiting particles is advantageously selected at a ratio of 20:80 to 80:20.

In addition, it may be advantageous for the layer to comprise a matrix material in which the zeolite particles and the biofilm-inhibiting particles are embedded. In this manner, the particles are fixed and held securely and fixed in place in the plastic pipe.

It may be favorable for the matrix material to comprise a thermoplastic polymer such as polyethylene, cross-linked polyethylene (PE-X), polypropylene, polybutene, or polyvinyl chloride and the copolymers thereof, and to preferably be made of said materials. These materials have favorable mechanical, physical, and chemical properties and, in addition, are low in cost and simple to process.

It may also be favorable for the zeolite particles and/or the biofilm-inhibiting particles to be evenly distributed throughout the matrix material, or for the concentration of the zeolite particles and/or the biofilm-inhibiting particles in the nanometer range to increase or decrease in a continuous manner from the exterior surface of the layer facing away from the fluid in the direction of the inner surface of the layer facing the fluid. Depending on the application, the distribution of the zeolite particles and/or the biofilm-inhibiting particles may be varied and/or adapted. If, for example, it is desired for the inner surface of a pipe (i.e., the surface coming into contact with the fluid) as well as the outer surface to be protected from the buildup of a biofilm, a homogeneous distribution is to be recommended. In contrast, if the intent is primarily to protect the inner surface of the pipe from the buildup of a biofilm, the concentration of zeolite particles and/or biofilm-inhibiting particles in the region of the inner surface offers advantages. In addition, if protection of the pipe from the buildup of a biofilm is desired on the inner surface and on the outer surface, it may be advantageous for the concentration of the zeolite particles and/or biofilm-inhibiting particles to increase from the center of the layer toward the inner surface and the outer surface.

In one modification of the present invention, it may additionally be favorable for the concentration of the zeolite particles to increase from the center of the layer toward the inner surface, with the concentration of the zeolite particles being very high near the inner surface and being very low or even zero at a farther distance from the inner surface. This may also apply in reverse to biofilm-inhibiting particles.

Thus, a layer results according to the invention that contains essentially only zeolite particles with biofilm-inhibiting ions or biofilm-inhibiting particles in the nanometer range in both edge regions.

The concentration of zeolite particles with biofilm-inhibiting ions and biofilm-inhibiting particles in the nanometer range may be selected such that a first partial layer is advantageously present in the layer, which contains zeolite particles with biofilm-inhibiting ions and a second partial layer is present, which contains biofilm-inhibiting particles in the nanometer range. A non-consistent gradient having a jump may advantageously be effective if the migration of ions is intended to begin in a delayed fashion.

In an advantageous embodiment, the plastic pipe has two or more layers, with the innermost layer facing the fluid being formed by the layer described in the advantageous embodiments described above, and the subsequent outer layer or layers comprising a polymer material. Due to the two-layer or multi-layer structure, a more robust pipe results that is able to withstand stronger mechanical loads; the respective layers may be configured in the manner of the intended function. In the case of a two-layer pipe, for example, the inner layer is configured in such a way that it prevents the buildup of microorganisms or contaminants, while the subsequent outer layer is configured, for example, so as to guarantee a greater degree of mechanical stability for the pipe.

Here, it may prove favorable for the outer layer or layers adjacent to the innermost layer to comprise a thermoplastic polymer such as polyethylene, cross-linked polyethylene (PE-X), polypropylene, polybutene, or polyvinyl chloride and the copolymers thereof, and to preferably be made of said materials.

Furthermore, it may prove favorable for the pipe to be two-layered or multi-layered and to be produced by means of a co-extrusion process. This is a particularly effective and economical method for the production of multi-layer pipes.

In addition, it may prove favorable for the layer with the zeolite particles having biofilm-inhabiting ions and biofilm-inhibiting particles in the nanometer range to be produced in a process in which a fluid is conducted in the lumen of the pipe and collects on the inner surface to form the layer.

The fluid may be a fluid in the form of a lacquer, for example, that contains the zeolite particles and biofilm-inhibiting particles.

In another form, the layer formation may be conducted from a gas phase.

Such a technique for producing the layer is very effective and may be used economically to produce multi-layer pipes.

In addition, it may prove favorable for the pipe to be two-layer or multi-layer and the layer thickness of the innermost layer facing the fluid to be 1 to 10% of the wall thickness of the pipe. In this layer thickness range, the desired buildup-preventing function of the innermost layer is guaranteed. At the same time, this results from only a relatively low use of material for the innermost layer, which has a cost-reducing effect on the production of the pipe. In addition, the relatively low thickness of the innermost layer has only a negligible effect on the mechanical material behavior of the overall pipe.

Here, it may be advantageous for the layer thickness of the innermost layer facing the fluid to be between 1 and 10% of the wall thickness of the pipe.

In addition to the advantageous embodiments of the pipe described above, all possible combinations thereof are conceivable.

The features and advantages of the invention shall be described in greater detail in the specification below with reference to the attached drawings, which are not to scale and which show the following:

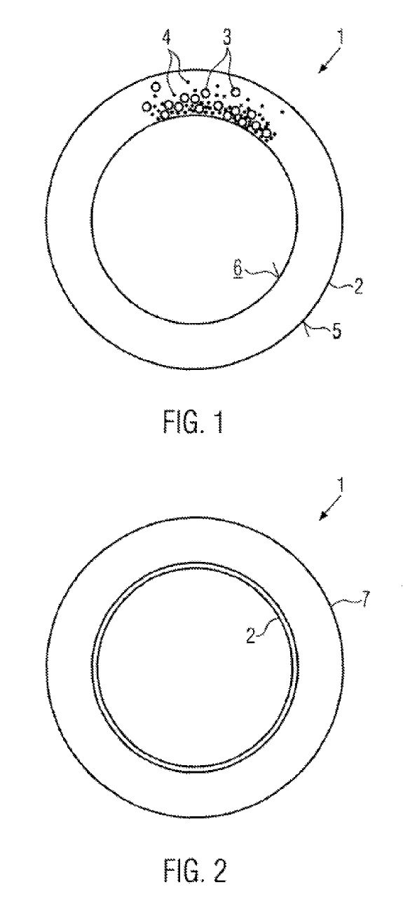

FIG. 1 cross sectional view of a single-layer pipe according to the invention

FIG. 2 cross sectional view of a two-layer pipe according to the invention

The depiction in FIG. 1, which is not to scale, shows a section through a single-layer pipe 1 according to the invention, with the pipe 1 having a layer 2 with an outer surface 5 and an inner surface 6. The layer 2 contains polyethylene as a matrix material, in which the zeolite particles 3 and the biofilm-inhibiting particles 4 are embedded. Here, the zeolite particles 3 have silver ions as biofilm-inhibiting ions, while the biofilm-inhibiting particles 4 are composed of silver and have a maximum diameter of 10 nm. The concentration of the zeolite particles and the biofilm-inhibiting particles is greatest in the region of the inner surface 6 and steadily declines in the direction of the outer surface 5.

The depiction in FIG. 2, which is not to scale, shows a section through a two-layer pipe 1 according to the invention that was produced in a co-extrusion process and that has an inner layer 2 and an outer layer 7 adjacent thereto. Here, the inner layer 2 corresponds to the layer shown in FIG. 1 and has the same structure. The outer layer 7 is made of PP. the inner layer has a thickness of approximately 1 mm, while the wall thickness of the pipe is approximately 15 mm.

1. A plastic molded part, preferably a plastic pipe, particularly for conveying or storing fluids, comprising at least one layer containing zeolite particles, in at least some of which ion-exchangeable ions have been replaced with biofilm-inhibiting ions, wherein the layer and/or an additional layer contains additional biofilm-inhibiting particles in the nanometer range.

2. The plastic molded part according to claim 1, wherein the biofilm-inhibiting ions preferably include copper ions and/or zinc ions and/or silver ions.

3. The plastic molded part according to claim 1, wherein the biofilm-inhibiting particles preferably contain copper and/or zinc and/or silver.

4. The plastic molded part according to claim 1, wherein the biofilm-inhibiting particles have a maximum diameter between 1 and 100 nm, preferably between 10 and 50 nm.

5. The plastic molded part according to claim 1, wherein the layer or an additional layer comprises a matrix material in which the zeolite particles and the biofilm-inhibiting particles are embedded.

6. The plastic molded part according to claim 1, wherein the matrix material comprises a thermoplastic polymer such as polyethylene, cross-linked polyethylene (PE-X), polypropylene, polybutene, or polyvinyl chloride and the copolymers thereof, and is preferably made of said materials.

7. The plastic molded part according to claim 1, wherein the zeolite particles and/or the biofilm-inhibiting particles are evenly distributed in the matrix material.

8. The plastic molded part according to claim 1, wherein the concentration of the zeolite particles and/or the biofilm-inhibiting particles in the nanometer range continuously increases or continuously decreases from the outer surface of the layer facing away from the fluid toward the inner surface of the layer facing the fluid.

9. The plastic molded part according to claim 1, wherein it is two-layer or multi-layer, with the innermost layer facing the fluid being formed by the layer and the outer layer or layers adjacent thereto comprising a polymer material.

10. The plastic molded part according to claim 1, wherein the outer layer or layers adjacent to the innermost layer comprise(s) a thermoplastic polymer such as polyethylene, cross-linked polyethylene (PE-X), polypropylene, polybutene, or polyvinyl chloride and is/are preferably made of said materials.

11. The plastic molded part according to claim 1, wherein it is two-layer or multi-layer and is produced by means of a co-extrusion process.

12. The plastic molded part according to claim 1, wherein the layer thickness of the innermost layer facing the fluid represents between 1 and 10% of the wall thickness of the pipe.

13. The plastic molded part according to claim 2, wherein the biofilm-inhibiting particles preferably contain copper and/or zinc and/or silver.

14. The plastic molded part according to claim 2, wherein the biofilm-inhibiting particles have a maximum diameter between 1 and 100 nm, preferably between 10 and 50 nm.

15. The plastic molded part according to claim 3, wherein the biofilm-inhibiting particles have a maximum diameter between 1 and 100 nm, preferably between 10 and 50 nm.

16. The plastic molded part according to claim 2, wherein the layer or an additional layer comprises a matrix material in which the zeolite particles and the biofilm-inhibiting particles are embedded.

17. The plastic molded part according to claim 3, wherein the layer or an additional layer comprises a matrix material in which the zeolite particles and the biofilm-inhibiting particles are embedded.

18. The plastic molded part according to claim 4, wherein the layer or an additional layer comprises a matrix material in which the zeolite particles and the biofilm-inhibiting particles are embedded.

19. The plastic molded part according to claim 2, wherein the matrix material comprises a thermoplastic polymer such as polyethylene, cross-linked polyethylene (PE-X), polypropylene, polybutene, or polyvinyl chloride and the copolymers thereof, and is preferably made of said materials.

20. The plastic molded part according to claim 3, wherein the matrix material comprises a thermoplastic polymer such as polyethylene, cross-linked polyethylene (PE-X), polypropylene, polybutene, or polyvinyl chloride and the copolymers thereof, and is preferably made of said materials.
